(19) United States
(12) Patent Application Publication
(10) Pub. No.: US 2026/0086224 A1
(43) Pub. Date: Mar. 26, 2026

(54) WHEEL POSITION DETECTION DEVICE

(71) Applicant: DENSO CORPORATION, Kariya-city (JP)

(72) Inventor: Lengchi CAO, Kariya-city (JP)

(21) Appl. No.: 19/404,280

(22) Filed: Dec. 1, 2025

Related U.S. Application Data
(63) Continuation of application No. PCT/JP2024/019921, filed on May 30, 2024.

(30) Foreign Application Priority Data
Jun. 7, 2023 (JP) 2023-094123

(51) Int. Cl. G01S 13/76; B60C 23/04; G01L 17/00; G01P 15/18; G07C 5/04

(52) U.S. Cl. CPC G01S 13/765; B60C 23/0416; B60C 23/0488; G01L 17/00; G01P 15/18; G07C 5/04

(57) ABSTRACT

A wheel position detection device for a vehicle includes: a wheel-side communication device having an acceleration sensor, a first control unit that stores a detection result of the acceleration sensor and generates a frame that stores identification information of each wheel-side communication unit, and a first communication unit; and a vehicle-side communication device having a second communication unit and a second control unit that determines the wheel-side communication device that has transmitted the frame. The second control unit transmits measurement start and end timings to each wheel-side communication device. A sensor angle between each wheel-side communication device and a wheel center is calculated based on the circumferential and radial accelerations. The second control unit specifies the wheel to which each wheel side communication device is attached, based on the accumulated angle of a change in the sensor angle or a magnitude of the accumulated angle.

### CROSS REFERENCE TO RELATED APPLICATION

The present application is a continuation application of International Patent Application No. PCT/JP2024/019921 filed on May 30, 2024, which designated the U.S. and claims the benefit of priority from Japanese Patent Application No. 2023-094123 filed on Jun. 7, 2023. The entire disclosures of all of the above applications are incorporated herein by reference.

### TECHNICAL FIELD

The present disclosure relates to a wheel position detection device that specifies and registers the wheel to which a wheel-side communication device is attached based on data transmitted from the wheel-side communication device attached to each wheel, and is suitable for application to a tire pressure monitoring system (hereinafter referred to as TPMS).

### BACKGROUND ART

Conventionally, a conceivable technique teaches a technique for detecting a wheel position using a detection signal from a wheel speed sensor in a direct type TPMS. This TPMS detects the time when the wheel has reached a specific rotation position based on the acceleration detection signal from an acceleration sensor (hereinafter referred to as the G sensor) installed in the wheel-side communication device on the wheel side, and also detects the rotation position of the wheel on the vehicle body side when a wireless signal is received from the wheel-side communication device. The wheel position is detected by monitoring a change in the relative angle. Specifically, the system monitors the change in the relative angle between the rotation position of the wheel detected on the wheel side and the rotation position of the wheel detected on the vehicle body side based on the deviation of a predetermined number of data, and detects the wheel position by determining whether the variation from the initial value exceeds an allowable value.

### SUMMARY

According to an example, a wheel position detection device for a vehicle may include: a wheel-side communication device having an acceleration sensor, a first control unit that stores a detection result of the acceleration sensor and generates a frame that stores identification information of each wheel-side communication unit, and a first communication unit; and a vehicle-side communication device having a second communication unit and a second control unit that determines the wheel-side communication device that has transmitted the frame. The second control unit transmits measurement start and end timings to each wheel-side communication device. A sensor angle between each wheel-side communication device and a wheel center is calculated based on the circumferential and radial accelerations. The second control unit specifies the wheel to which each wheel side communication device is attached, based on the accumulated angle of a change in the sensor angle or a magnitude of the accumulated angle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a schematic configuration of a vehicle equipped with a TPMS having a wheel position detection function according to a first embodiment;

FIG. 2A is a diagram illustrating a block configuration of a wheel side communication device;

FIG. 2B is a diagram illustrating a block configuration of a vehicle side communication device;

FIG. 3 is a diagram showing the acceleration in the X-axis and the acceleration in the Z axis applied to the wheel-side communication device as the wheel rotates, and the sensor angle, which is the angle at which the wheel side communication device is located with respect to the center of the wheel;

FIG. 4A is a diagram showing the change over time in the accelerations along the X-axis and Z-axis and the change over time in the sensor angle in a wheel-side communication device attached to a left wheel;

FIG. 4B is a diagram showing the change over time in the accelerations along the X-axis and Z-axis and the change over time in the sensor angle in a wheel-side communication device attached to a right wheel;

FIG. 5 is a diagram showing the relationship between the state when a vehicle turns right and the turning radius of each wheel;

FIG. 6 is a diagram showing the change over time in the acceleration on the X-axis of each of the four wheels and the change over time in the sensor angle;

FIG. 7A is a diagram showing a situation in which a vehicle capable of executing the wheel position detection is turning;

FIG. 7B is a diagram showing a situation in which a vehicle capable of executing the wheel position detection is turning;

FIG. 8 is a diagram showing an example of the time change of the acceleration in the X axis and the time change of the sensor angle and the number of rotation periods in a wheel-side communication device attached to a left wheel;

FIG. 9 is a diagram showing the acceleration in the X-axis and the acceleration in the Z axis applied to the wheel-side communication device as the right wheel rotates, and the sensor angle, at which the wheel side communication device is located with respect to the center of the wheel;

FIG. 10 is a diagram showing an example of the time change of the acceleration in the X axis, the time change of the acceleration in the Z axis, the time change of the sensor angle and the number of rotation periods in a wheel-side communication device attached to a left wheel;

FIG. 11 is a diagram showing an example of the time change of the acceleration in the X axis, the time change of the acceleration in the Z axis, the time change of the sensor angle and the number of rotation periods in a wheel-side communication device attached to a right wheel;

FIG. 12A is a flowchart showing details of a wheel position detection process;

FIG. 12B is a flowchart showing details of a wheel position detection process following FIG. 12A;

FIG. 13 is a time chart when the wheel position detection process is executed;

FIG. 14A is a waveform diagram of the sensor angle before correction;

FIG. 14B is a waveform diagram of the sensor angle after correction;

FIG. 15 is a diagram illustrating a change in the acceleration on the X-axis and the corresponding pre-correction angle and post-correction angle;

FIG. 16A is a flowchart showing details of a wheel position detection process according to a second embodiment; and

FIG. 16B is a flowchart showing details of a wheel position detection process following FIG. 16A.

### DETAILED DESCRIPTION

When using the detection signal of the wheel speed sensor, since the detection signal of the wheel speed sensor has an error, it may be difficult to detect the wheel position quickly and accurately.

An object of the present embodiments is to provide a wheel position detection device that is capable of detecting the wheel position more quickly and with higher accuracy.

According to an aspect of the present embodiments, a wheel position detection device for a vehicle, includes: a wheel-side communication device attached to each of a plurality of wheels having tires; and a vehicle-side communication device provided on a vehicle body side. Each wheel-side communication device respectively attached to each of the plurality of wheels includes: an acceleration sensor that detects a circumferential acceleration that is an acceleration along a circumference direction of each wheel to which the wheel side communication device is attached and a radial acceleration that is an acceleration along a radial direction of each wheel to which the wheel-side communication device is attached; a first control unit that stores a detection result of the acceleration sensor and generates a frame that stores individual identification information assigned to each of the wheel-side communication units; and a first communication unit that executes bidirectional communication with the vehicle-side communication device. The bidirectional communication includes a transmission of the frame. The vehicle-side communication device includes: a second communication unit that receives the frame and transmits an instruction signal to each of the wheel-side communication devices; and a second control unit that determines which of the plurality of wheels the wheel-side communication device that has transmitted the frame is attached to, and associates and registers a relationship between the identification information and the plurality of wheels. The second control unit transmits a measurement start timing and a measurement end timing to each of the wheel-side communication devices so as to cause the wheel-side communication devices to measure the acceleration when the vehicle is in a turning state. The second control unit or the first control unit provided in each of the wheel-side communication devices calculates the sensor angle based on the circumferential acceleration and the radial acceleration, using an angle at which the wheel-side communication device is located with respect to a wheel center of the wheel to which the wheel-side communication device is attached as a sensor angle. The second control unit or the first control unit provided in each of the wheel-side communication devices calculates a accumulated angle acquired by accumulating a change in the sensor angle from the measurement start timing to the measurement end timing, or a accumulated number of rotations of the wheel-side communication device rotated around the wheel center, based on the sensor angle. The second control unit specifies which of the plurality of wheels each of the wheel side communication devices is attached to, based on the accumulated angle in each of the wheel-side communication devices or the magnitude of the accumulated angle.

In this manner, when the vehicle is turning, the sensor angle of each wheel-side communication device is calculated based on the circumferential acceleration and radial acceleration detected by the wheel-side communication device. The accumulated angle and the accumulated number of rotations are calculated from the sensor angle, and the wheel position is detected based on the feature that the accumulated angle and the accumulated number of rotations are different from each wheel depending on the wheel position.

In this manner, it is possible to specify which of a plurality of wheels each wheel-side communication device is attached to, and to execute the wheel position detection. Furthermore, according to this type of wheel position detection, it is possible to execute the wheel position detection more quickly and with higher accuracy, regardless of an error in the detection signal of the wheel speed sensor, since the wheel position detection can be executed without using the detection signal of the wheel speed sensor.

According to a second aspect of the present embodiments, the second control unit or the first control unit provided in each of the wheel-side communication devices calculates the sensor angle based on only one of the circumferential acceleration and the radial acceleration, using an angle at which the wheel-side communication device is located with respect to a wheel center of the wheel to which the wheel-side communication device is attached as a sensor angle. The second control unit or the first control unit provided in each of the wheel-side communication devices calculates a accumulated angle acquired by accumulating a change in the sensor angle from the measurement start timing to the measurement end timing, or a accumulated number of rotations of the wheel-side communication device rotated around the wheel center, based on the sensor angle. The second control unit specifies which of the plurality of wheels each of the wheel side communication devices is attached to, based on the accumulated angle in each of the wheel-side communication devices or the magnitude of the accumulated angle.

In this manner, when the vehicle is turning, the accumulated angle and the accumulated number of rotations can be calculated based on the acceleration of one axis detected by the acceleration sensor, and the wheel position can be detected. Furthermore, according to this type of wheel position detection, it is possible to execute the wheel position detection more quickly and with higher accuracy, regardless of an error in the detection signal of the wheel speed sensor, since the wheel position detection can be executed without using the detection signal of the wheel speed sensor.

The reference numerals in parentheses attached to the components and the like indicate an example of correspondence between the components and the like and specific components and the like described in an embodiment to be described below.

Embodiments of the present disclosure will be described below with reference to the drawings. In the following embodiments including other embodiments to be described below, the same or equivalent components will be described with the same reference numerals.

### First Embodiment

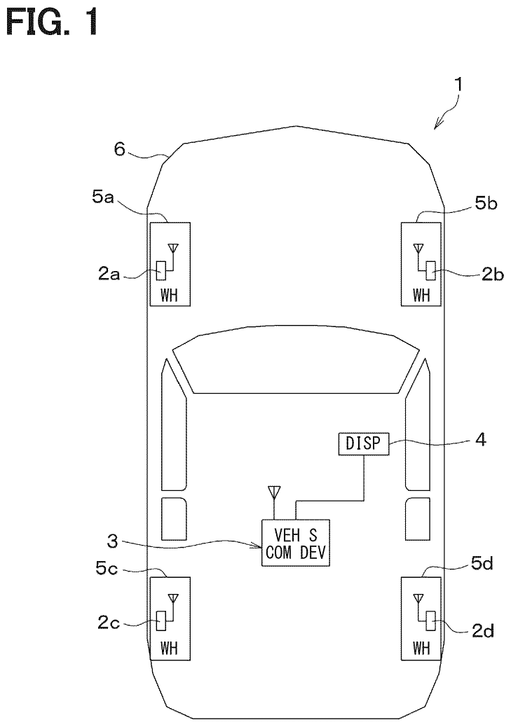

A first embodiment will be described with reference to FIGS. 1 to 13. In this embodiment, a TPMS to which a wheel position detection device is applied will be described as an example. FIG. 1 is a block diagram showing an overall configuration of a TPMS. The upper direction of the drawing corresponds to the front of the vehicle 1, the lower direction of the drawing corresponds to the rear of the vehicle 1, and the right left direction of the drawing corresponds to the right left direction of the vehicle 1.

As shown in FIG. 1, the TPMS is mounted on a vehicle 1 and includes wheel-side communication devices 2a to 2d, a vehicle-side communication device 3 and a display device 4. In this embodiment, the wheel side communication devices 2a to 2d and the vehicle side communication device 3 constitute a wheel position detection device.

The wheel-side communication devices 2a to 2d are attached to the four wheels 5a to 5d of the vehicle 1, respectively. Each of the wheel side communication devices 2a to 2d detects the air pressure of the tires attached to the wheels 5a to 5d and stores data of the detection signal indicating the detection result in a frame and transmits it. In addition, the wheel-side communication devices 2a to 2d are capable of bidirectional communication with the vehicle-side communication device 3, and when the wheel-side communication devices 2a to 2d receive an instruction from the vehicle-side communication device 3, the wheel-side communication devices 2a to 2d enter a wheel position detection mode and execute a process corresponding to the instruction, such as transmitting data necessary for the wheel position detection (hereinafter referred to as position detection data).

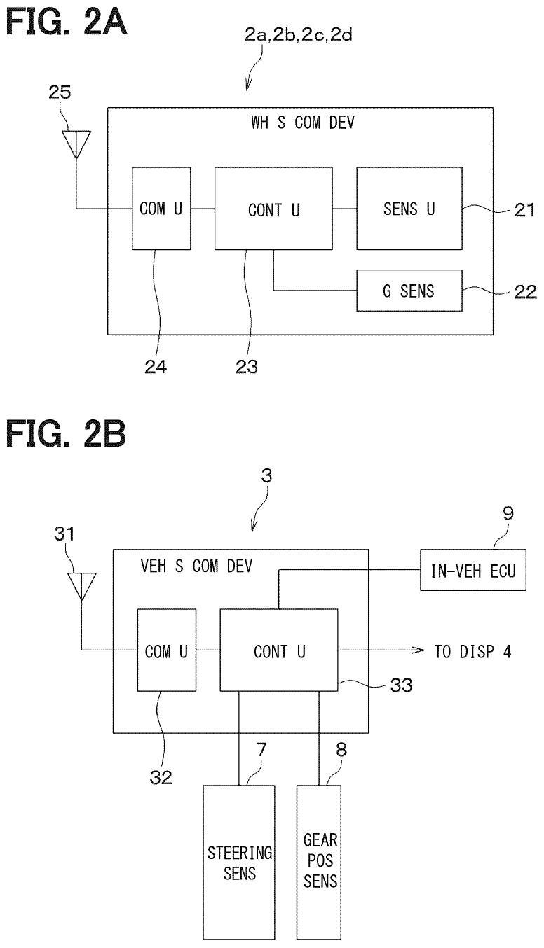

Here, the vehicle side communication device 3 is attached to the vehicle body 6 side of the vehicle 1, receives a frame transmitted from the wheel side communication devices 2a to 2d, and executes various processes, calculations, and the like based on the data of the detection signal stored in the frame so as to detect the tire pressure. In addition, when detecting the wheel position, the vehicle-side communication device 3 issues an instruction to each of the wheel-side communication devices 2a to 2d to cause each of the wheel-side communication devices 2a to 2d to transmit a frame including position detection data, and executes the wheel position detection based on that data. FIGS. 2A and 2B show block configurations of the wheel side communication devices 2a to 2d and the vehicle side communication device 3.

As shown in FIG. 2A, each of the wheel side communication devices 2a to 2d includes a sensing unit 21, a G sensor 22, a control unit 23, a communication unit 24, and an antenna 25.

The sensing unit 21 is configured to include a pressure sensor and a temperature sensor, for example, and outputs a detection signal in accordance with tire air pressure and a detection signal in accordance with the temperature. The sensing unit 21 is configured to output a detection signal in accordance with tire air pressure and a detection signal in accordance with the temperature at each predetermined sampling period.

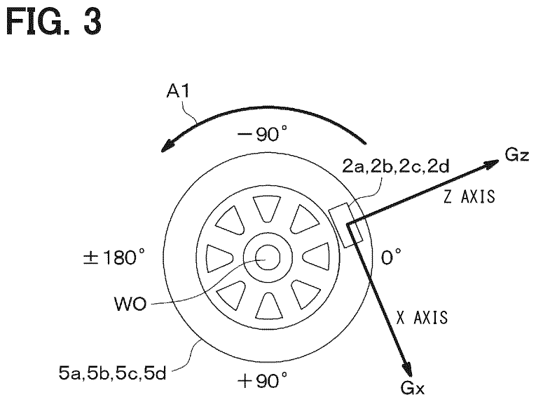

The G sensor 22 detects the acceleration caused by the rotation of the wheels 5a to 5d to which the wheel-side communication devices 2a to 2d are attached. In this embodiment, the G sensor 22 detects the acceleration along two axes. Specifically, as shown in FIG. 3, the circumferential direction of the wheels 5a to 5d is defined as the X-axis direction, and the radial direction is defined as the Z-axis direction. The G sensor 22 detects the acceleration in two axes, the X-axis direction and the Z-axis direction. Hereinafter, the acceleration in the X-axis direction, i.e., the circumferential acceleration, will be referred to as acceleration Gx, and the acceleration in the Z-axis direction, i.e., the radial acceleration, will be referred to as acceleration Gz.

The G sensor 22 also outputs a detection signal corresponding to the acceleration at a sampling period that is the same as or different from the sampling period of the sensing unit 21. More specifically, the G sensor 22 outputs a detection signal according to the acceleration under a condition that the direction in which the wheels 5a to 5d rotate in one direction is defined as the positive direction and the direction in which the wheels rotate in the reverse direction is defined as the negative direction. When the vehicle 1 moves forward, the direction in which the right wheels 5b, 5d rotate is defined as the positive direction, and the left wheels 5a, 5c rotate in the opposite as the negative direction.

For example, in FIG. 3, it is assumed that the wheels 5a to 5d are the left wheels 5a and 5c, the left side of the drawing is the front of the vehicle 1, and the right side of the drawing is the rear of the vehicle 1. In this case, when the vehicle 1 moves forward, the left wheels 5a, 5c rotate counterclockwise as indicated by the arrow A1 in the drawing, and the sensor angle α, which is the angle at which the wheel-side communication devices 2a to 2d equipped with the G sensor 22 are positioned relative to the wheel center WO, changes. The sensor angle α can be expressed as 0° when the wheel side communication devices 2a to 2d are located at the far right side relative to the wheel center WO, −90° when the wheel side communication devices 2a to 2d are located at the far top relative to the wheel center WO, ±180° when the wheel side communication devices 2a to 2d are located at the far left side relative to the wheel center WO, and +90° when the wheel side communication devices 2a to 2d are located at the far top relative to the wheel center WO. In the case of the left wheels 5a, 5c, the far right side with respect to the wheel center WO corresponds to the rearmost side of the vehicle 1, and the far left side corresponds to the frontmost side of the vehicle 1.

For the right wheels 5b, 5d, the manner in which the sensor angle α is indicated is the same as for the left wheels 5a, 5c, but since the wheel side communication devices 2a to 2d are mounted in the same direction for each wheel 5a to 5d, the correspondence with the front rear direction of the vehicle 1 is opposite. Thus, the far right side with respect to the wheel center WO corresponds to the frontmost side of the vehicle 1, and the far left side corresponds to the rearmost side of the vehicle 1. When the vehicle 1 moves forward, the right wheels 5b, 5d rotate clockwise, which is the opposite direction to the direction of the arrow A1 in FIG. 3. Therefore, the output corresponding to the acceleration Gx detected by the G sensor 22 has opposite positive and negative signs for the right wheels 5b, 5d and the left wheels 5a, 5c.

Here, in the following, for example, as shown in FIG. 6 described later, in order to make it easier to compare the output of acceleration Gx detected by the G sensor 22 in each wheel 5a to 5d, the positive and negative signs may be matched for the right wheels 5b, 5d and the left wheels 5a, 5c.

The control unit 23 corresponds to the first control unit, includes a computer equipped with a CPU, a ROM, a RAM, an I/O, a timer, and the like, and executes a predetermined process according to a program stored in the ROM or the like.

Specifically, the control unit 23 receives a detection signal regarding the tire air pressure from the sensing unit 21, processes the detection signal and, if necessary, manipulates the detection signal to generate data indicating the detection result of the tire air pressure (hereinafter referred to as data relating to the tire air pressure). The control unit 23 then stores the data relating to the tire air pressure together with the ID information of each of the wheel-side communication devices 2 a to 2 d in a frame to be transmitted, and then transmits the frame to the communication unit 24. The above process of transmitting the signal to the communication unit 24 is executed repeatedly every predetermined regular transmission period in accordance with the above program.

The control unit 23 is basically in a regular transmission mode in which it transmits a frame including the data on the tire air pressure together with ID information to the vehicle-side communication device 3 at a predetermined regular transmission period. In addition, when the control unit 23 receives an instruction to start the acceleration measurement from the vehicle-side communication device 3 based on the bidirectional communication, the control unit 23 enters the wheel position detection mode and starts measuring the acceleration Gx and acceleration Gz based on the detection signal of the G sensor 22 in order to detect the wheel position. The sampling period of the acceleration by the G sensor 22 is arbitrary, and, for example, the sampling period is set to a certain period that allows the acceleration to be measured multiple times during one rotation of the wheels 5a to 5d, such as 10 ms. Furthermore, based on an instruction from the vehicle-side communication device 3, the control unit 23 executes the process to store the measured acceleration data as position detection data together with the ID information of each of the wheels 5a to 5d in a frame and transmit the frame.

Furthermore, when the control unit 23 receives an instruction from the vehicle-side communication device 3 based on the bidirectional communication to terminate the wheel position detection, the control unit 23 terminates the measurement of the acceleration and also terminate the transmission of the frame storing the position detection data. Then, the control unit 23 switches from the wheel position detection mode to the regular transmission mode, and executes the regular transmission of a frame that stores data relating to the tire air pressure.

The communication unit 24 corresponds to a first communication unit that executes the bidirectional communication with the vehicle-side communication device 3 via an antenna 25. Specifically, the communication unit 24 functions as an output unit that transmits the frame sent from the control unit 23 to the vehicle-side communication device 3 via the antenna 25, and as an input unit that receives the instruction signal indicating an instruction from the vehicle-side communication device 3. The communication form used by the communication unit 24 is arbitrary, and, for example, the bidirectional communication between the wheel side communication devices 2a to 2d and the vehicle side communication device 3 is executed based on the BLE (i.e., Bluetooth Low Energy) standard. Here, “Bluetooth” is a registered trademark.

The antenna 25 is a communication antenna corresponding to the communication form of the communication unit 24, and is built in, for example, the wheel-side communication devices 2a to 2d and has a function of a transmission and reception antenna capable of the bidirectional communication. Here, the function of the transmission and reception antenna do not need to be realized by a single antenna, alternatively, the function may be realized by a transmission antenna and a reception antenna which are separated from each other.

The wheel side communication devices 2a to 2d configured as described above is attached to, for example, an air injection valve in each of the wheels 5a to 5d and is disposed so that the sensing unit 21 is exposed inside the tire. As a result, each of the wheel-side communication units 2a to 2d detects the tire air pressure and transmits a frame via the antenna 25 at predetermined regular transmission periods. Furthermore, each of the wheel-side communication devices 2a to 2d transmits a frame storing data for position detection based on an instruction from the vehicle-side communication device 3 when detecting the wheel position.

As shown in FIG. 2B, the vehicle-side communication device 3 includes an antenna 31, a communication unit 32, and a control unit 33.

The antenna 31 is a single common antenna that collectively receives frames transmitted from each of the wheel-side communication units 2a to 2d and is fixed to the vehicle body 6. The antenna 31 may be provided only for the TPMS, but if an antenna provided for the smart entry system is used, it is possible to reduce the number of parts by standardizing the parts. “Smart Entry” is a registered trademark.

The communication unit 32 corresponds to a second communication unit that executes the bidirectional communication with each of the wheel-side communication devices 2a to 2d via the antenna 31. Specifically, when the frame transmitted from each of the wheel side communication devices 2a to 2d is received by the antenna 31, the communication unit 32 functions as an input unit that inputs the frame and transmits the frame to the control unit 33. The communication unit 32 also functions as an output unit that transmits an instruction signal indicating an instruction sent from the control unit 33 to the vehicle-side communication device 3.

The control unit 33 corresponds to the second control unit, includes a computer equipped with a CPU, a ROM, a RAM, an I/O, and the like, and executes a predetermined process according to a program stored in the ROM or the like.

Specifically, the control unit 33 executes the wheel position detection process based on an instruction from the vehicle-side communication device 3. That is, the control unit 33 receives, via the communication unit 32, frames storing position detection data from each of the wheel side communication devices 2a to 2d. Then, the control unit 33 specifies to which of the four wheels 5a to 5d each wheel side communication device 2a to 2d is attached, and registers the ID information assigned to each wheel side communication device 2a to 2d by connecting the ID information to the wheel position, i.e., the wheel to which the wheel side communication device 2a to 2d is attached.

For example, when a user presses a start switch of the wheel position detection (not shown), the control unit 33 executes the wheel position detection process, and when the start condition for the wheel position detection is satisfied, the control unit 33 outputs an instruction signal for instructing to start the acceleration measurement and executes the wheel position detection process. The details of this wheel position detection process will be described later. By this wheel position detection process, the wheels to which the wheel-side communication devices 2a to 2d are attached are associated with and registered with the ID information of each of the wheel-side communication devices 2a to 2d. Then, when this registration is completed, the control unit 33 terminates the wheel position detection process, and outputs an instruction signal for instructing each of the wheel-side communicators 2a to 2d to terminate the acceleration measurement. As a result, the control unit 23 of each of the wheel-side communication units 2a to 2d switches to the periodic transmission mode and begins to periodically transmit the frame that stores the data relating to the tire air pressures.

It is optional whether the vehicle-side communication device 3 outputs an instruction signal to each of the wheel-side communication devices 2a to 2d to instruct them to terminate the acceleration measurement. That is, after the time when the wheel position detection process is expected to terminate has elapsed, the wheel side communication devices 2a to 2d can automatically switch to a regular transmission period of a frame for normal tire air pressure detection.

Furthermore, detection signals from the steering angle sensor 7 and the gear position sensor 8 are input to the control unit 33, and these detection signals are used when executing the wheel position detection process. Furthermore, the data relating to the vehicle speed is input to the control unit 33 from another in-vehicle ECU 9 such as a meter ECU. Here, the detection signals from the steering angle sensor 7 and the gear position sensor 8 do not have to be input directly to the control unit 33. If another ECU detects the steering angle and the gear position from these detection signals, the detection results may be transmitted from that ECU.

Furthermore, the control unit 33 executes various signal processing and calculations based on the data indicating the detection results stored in the received frame to determine the tire air pressure, and outputs an electric signal corresponding to the determined tire air pressure to the display 4. For example, the control unit 33 specifies the tire air pressure of each of the wheels 5a to 5d and outputs the data to the display device 4. Alternatively, the control unit 33 compares the determined tire air pressure with a predetermined threshold value Th, and if it detects that the tire air pressure has dropped, the control unit 33 outputs data indicating the tire air pressure reduction to the display device 4. Thus, the information is transmitted to the display device 4, such as the data on the tire air pressures of the four wheels 5a to 5d or information that the tire air pressure of any one of the wheels 5a to 5d has dropped.

The display device 4 is disposed in a place visible to a driver as illustrated in FIG. 1 and configured by using, for example, a display and a warning lamp provided in an instrument panel in the vehicle 1. For example, when the data on the tire air pressure of each of the wheels 5a to 5d is transmitted from the control unit 33, the display device 4 displays the tire air pressure of each of the wheels 5a to 5d as a numerical value. Furthermore, when the data indicating that the tire air pressure has dropped is transmitted from the control unit 33, the display device 4 notifies the driver of the drop in tire air pressure by displaying that information.

The TPMS to which the wheel position detection device of this embodiment is applied is configured as described above.

Next, the operation of the TPMS of this embodiment will be described. Prior to that, a method of the wheel position detection executed by the TPMS of this embodiment will be described.

### (Method of Wheel Position Detection)

In the TPMS of this embodiment, the wheel position detection is executed based on the accelerations Gx and Gz acquired from the detection signal of the G sensor 22.

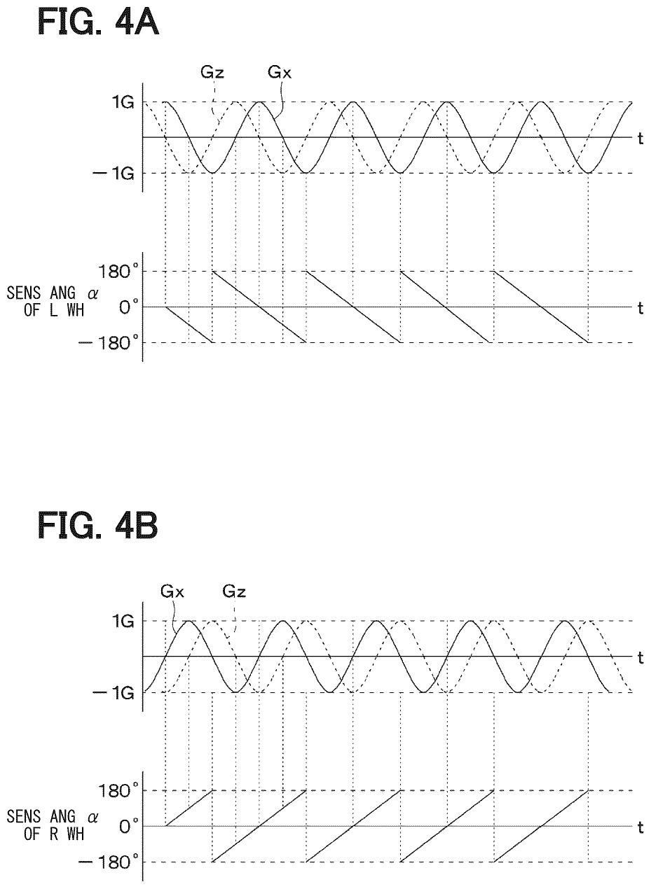

As described above, in FIG. 3, it is assumed that the wheels 5a to 5d are the left wheels 5a and 5c, the left side of the drawing is the front of the vehicle 1, and the right side of the drawing is the rear of the vehicle 1, and the vehicle 1 moves forward from a state in which the wheel-side communication devices 2a and 2c are located at a position where the sensor angle α is 0°. In this case, if the centrifugal acceleration component accompanying the change in the traveling speed of the vehicle 1 is excluded and only the gravitational acceleration component is extracted, the time changes of the acceleration Gx and the acceleration Gz are shown as a sine waveform that changes with time in accordance with the rotation of the wheels, as shown in the upper part of FIG. 4A. The acceleration Gx has a waveform whose phase is delayed ¼ period behind that of the acceleration Gz. The change over time in the sensor angle α of the wheel-side communication units 2a, 2c has a waveform that linearly transitions from 0° to −180° and then linearly returns from 180° to 0°, as shown in the lower part of FIG. 4A. Therefore, the sensor angle α can be detected based on the waveforms of the acceleration Gx and the acceleration Gz.

Similarly, in the case of the right wheels 5b and 5d, the changes over time in the accelerations Gx and Gz are shown by sine waveforms that change with the rotation of the wheels, as shown in the upper part of FIG. 4B. The acceleration Gx has a waveform whose phase is advanced ¼ period beyond that of the acceleration Gz. The change over time in the sensor angle α of the wheel-side communication units 2b, 2d has a waveform that linearly transitions from 0° to +180° and then linearly returns from −180° to 0°, as shown in the lower part of FIG. 4B. Therefore, the sensor angle α can be detected based on the waveforms of the acceleration Gx and the acceleration Gz.

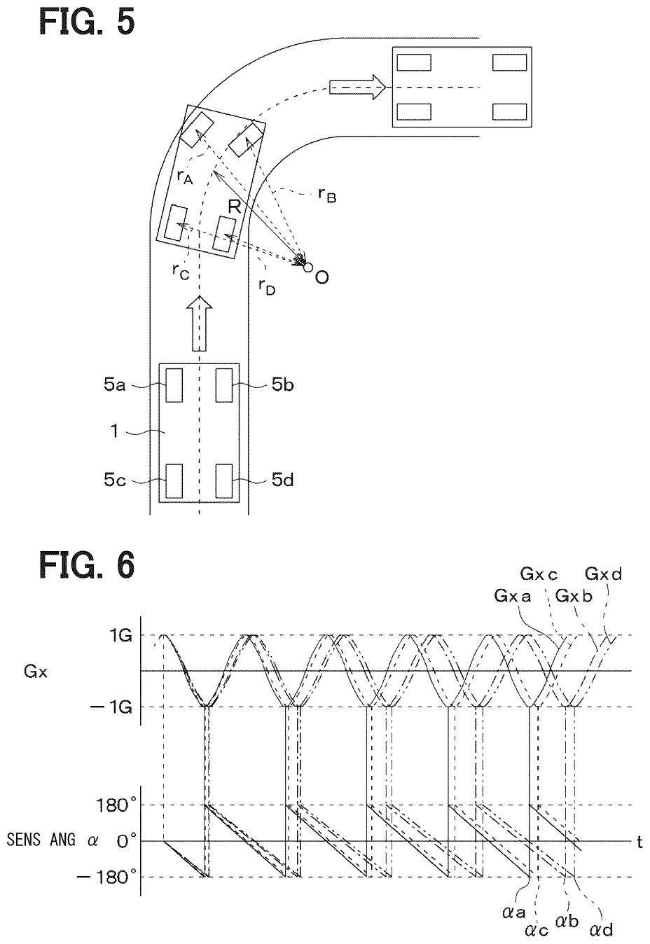

As shown in FIG. 5, when the vehicle 1 turns, the turning radius of each of the wheels 5a to 5d is different compared to the turning radius R of the vehicle center depending on the distance from the turning center to each of the wheels 5a to 5d. For example, as shown in FIG. 5, a case will be considered in which the vehicle 1 turns clockwise around a point O as the turning center.

If the rotation radius of each of the wheels 5a to 5d is defined as r_{A}, r_{B}, r_{C}, and r_{D}, respectively, the relationship of “r_{A}>r_{C}>r_{B}>r_{D}” is established. Therefore, a difference occurs in the rotation speed of each of the wheels 5a to 5d during turning. Therefore, if the acceleration Gx in each wheel side communication unit 2a to 2d is represented by Gxa to Gxd, respectively, the change over time in the accelerations Gxa to Gxd is represented by the sine waveform shown in the upper part of FIG. 6, and the phase becomes faster in the order of “Gxa>Gxc>Gxb>Gxd”. That is, the phase of the acceleration Gxc is slightly delayed compared to the acceleration Gxa, the phases of the accelerations Gxb and Gxd are even slower than the accelerations Gxa and Gxc, and the phase of the acceleration Gxd is slightly delayed compared to the acceleration Gxb. Similarly, as shown in the lower part of FIG. 6, the time changes of the sensor angles αa to αd of the wheel-side communication devices 2a to 2d also gradually differ among the wheels 5a to 5d.

Therefore, by utilizing the inner wheel difference of each wheel 5a to 5d, the magnitude of the accumulated angle obtained by accumulating the changes in the sensor angle α of the wheel side communication devices 2a to 2d after the same amount of time has elapsed from the start of measurement, or the magnitude of the accumulated number of rotations obtained by accumulating the number of rotations, follows the order of the phase of the acceleration. In other words, when the vehicle 1 turns clockwise, the magnitude of the accumulated angle or the accumulated number of rotations has the following relationship of “left front wheel 5a>left rear wheel 5c>right front wheel 5b>right rear wheel 5d”. Conversely, when the vehicle 1 turns counterclockwise, the magnitude of the accumulated angle or the accumulated number of rotations has the following relationship of “right front wheel 5b>right rear wheel 5d>left front wheel 5a>left front wheel 5c”.

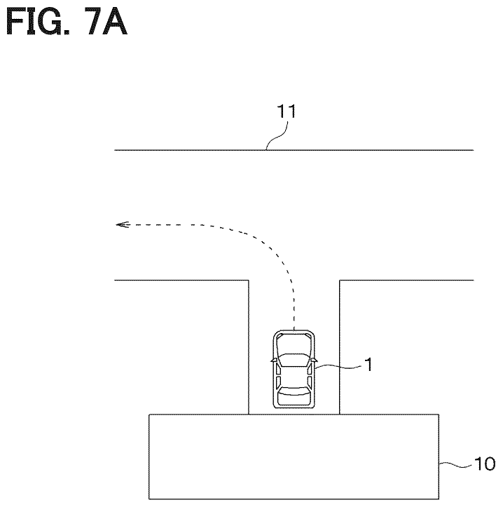

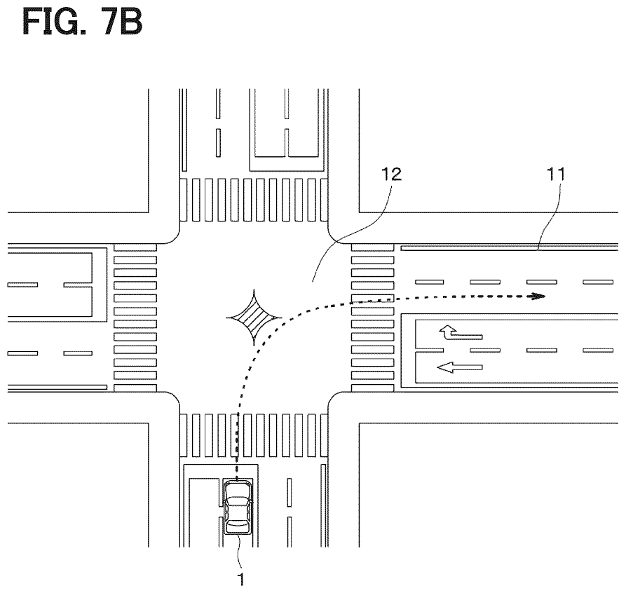

Based on this relationship, by calculating the accumulated angle or the accumulated number of rotations within a specific time period while the vehicle 1 is turning, it is possible to detect the wheel position of the wheel-side communication device 2a to 2d attached to any one of the wheels 5a to 5d. Examples of such turning movements include a case where the vehicle 1 turns from an automobile repair facility 10 such as a dealership to enter the facility or an adjacent road 11 as shown in FIG. 7A, and a case where the vehicle 1 turns right or left at an intersection 12 as shown in FIG. 7B. When executing such a turn movement, if it is necessary to detect the wheel position, the user presses a start switch of the wheel position detection (not shown) to execute the wheel position detection process.

Furthermore, it may be preferable that the wheel position detection is executed when the vehicle 1 is turning under the condition that the steering angle is equal to or greater than a certain angle and a vehicle speed is equal to or greater than a certain speed, that is, when it is confirmed that the vehicle 1 is actually turning. Therefore, when the wheel position detection process is executed, if the condition that a steering angle is equal to or greater than a certain angle and a vehicle speed is equal to or greater than a certain speed is satisfied, the vehicle side communication device 3 can instruct each wheel side communication device 2a to 2d to start the acceleration measurement.

On the other hand, when the wheel position detection is completed, the acceleration measurement may be terminated. Therefore, when the wheel position detection process is executed, when it has been specified which of the wheels 5a to 5d the wheel side communication devices 2a to 2d are attached to, the vehicle side communication device 3 may instruct each wheel side communication device 2a to 2d to terminate the acceleration measurement. Also, when all the data required for detecting the wheel position while the vehicle is turning is collected, the acceleration measurement may be terminated. Alternatively, when the turning movement is completed after the vehicle was turning, the data suitable for the wheel position detection is no longer available. Thus, in this case, the acceleration measurement may be terminated. For this reason, when the steering angle falls below a certain angle, or when the vehicle speed is maintained below a certain speed for a certain period of time or more, the vehicle side communication device 3 instructs each wheel side communication device 2a to 2d to terminate the acceleration measurement. The condition for the vehicle speed to be equal to or lower a certain speed includes a condition that the vehicle speed is maintained for a certain period of time or more. This is because it is estimated that the vehicle may stop temporarily when turning right or left, and the acceleration measurement is not stopped in a case where such a situation occurs.

In this way, the wheel position can be detected based on the accumulated angle or the accumulated number of rotations. Here, it may be preferable that the acceleration data used in this case is collected for the same period, that is, between the measurement start timing and the end timing which are the same as those of the accumulated angle or the accumulated number of rotations. For this reason, it is necessary to synchronize the measurement start timing and the measurement end timing of each of the wheel side communication devices 2a to 2d. As such a method, for example, the following methods (1) and (2) can be considered.

(1) Immediately before sampling of the acceleration measurement, clock synchronization is executed between each of the wheel-side communication devices 2a to 2d and the vehicle-side communication device 3. When the vehicle-side communication device 3 issues a broadcast instruction to each of the heel-side communication devices 2a to 2d, each of the wheel-side communication devices 2a to 2d responds to the instruction simultaneously. Each of the wheel-side communication devices 2a to 2d measures the acceleration from the start of measurement until each of the wheel-side communication devices 2a to 2d receives an instruction to terminate the measurement, and each of the wheel-side communication devices 2a to 2d or the vehicle-side communication device 3 executes the process required for the wheel position detection.

(2) The clock synchronization is not executed, and when the condition for starting the wheel position detection is satisfied, the vehicle-side communication device 3 issues a broadcast instruction to each of the wheel-side communication devices 2a to 2d to start the measurement. Each of the wheel-side communication device 2a to 2d responds individually within a certain period of time after receiving an instruction to start the measurement, and executes the acceleration measurement from the start of measurement until each of the wheel-side communication devices 2a to 2d receives an instruction to terminate the measurement, while each wheel-side communication device 2a to 2d or the vehicle-side communication device 3 executes the process required for the wheel position detection.

Either of the methods (1) or (2) may be used. The method (1) can eliminate delays between the wheel-side communication devices 2a to 2d with respect to the data communication from the wheel-side communication devices 2a to 2d to the vehicle-side communication device 3, but it is necessary to have a configuration for the clock synchronization. On the other hand, in the method (2), since there is no need to synchronize the clock, a delay may occur between the wheel-side communication devices 2a to 2d with respect to the data communication from the wheel-side communication devices 2a to 2d to the vehicle-side communication device 3. However, since there is no need for technique to synchronize the clock, the configuration can be simplified.

For this reason, in this embodiment, the method (2) is used to synchronize the measurement start timing and the measurement end timing without synchronizing the clock, and the accumulated angle or the accumulated number of rotations is calculated.

The calculation of the accumulated angle or the accumulated number of rotations can also be executed by the following two methods (a) and (b).

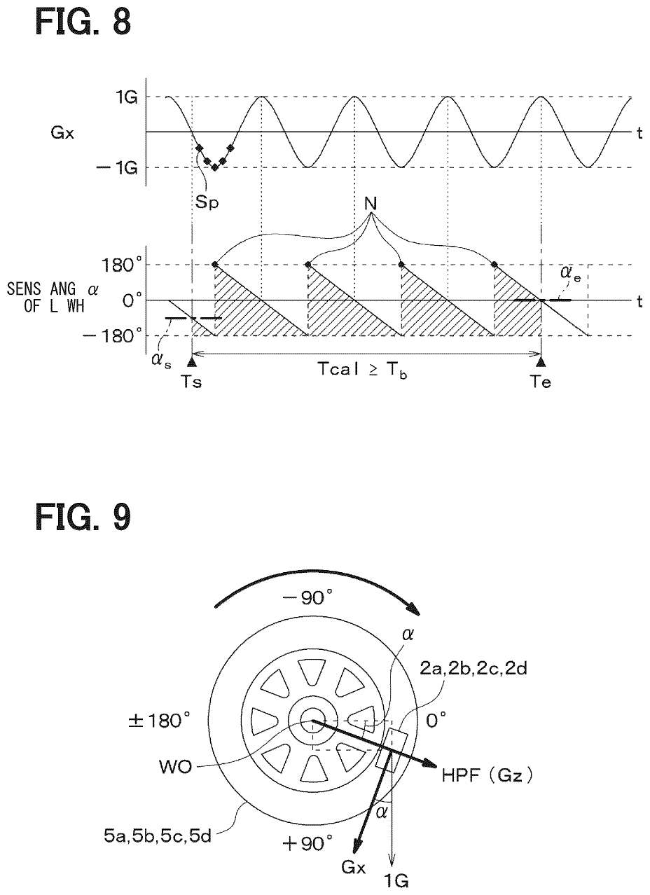

First, as a pre-condition, the acceleration Gx changes like a sine waveform in association with the rotation of the wheel as shown in the upper part of FIG. 8. Regarding the sensor angle α, in the case of the left wheels 5a, 5c, the sensor angle α repeatedly changes from 180° to −180° in response to the change in the acceleration Gx, as shown in the lower part of FIG. 8. With reference to this drawing, two methods (a) and (b) will be described.

(a) All angle information during a period Tcal from the measurement start timing Ts to the measurement end timing Te is calculated. Then, as shown in the lower part of FIG. 8, if the change amount of the total angle of the hatched portion in the drawing is calculated for the change in the sensor angle α from the measurement start timing Ts to the measurement end timing Te along the time axis, the change amount of the total angle corresponds to the accumulated angle θ. When calculating the accumulated number of rotations, the accumulated number of rotations can be grasped as a value proportional to the accumulated angle θ, that is, a value acquired by dividing the accumulated angle θ by 360°.

The calculation of the accumulated angle θ and the accumulated number of rotations may be executed by the control unit 23 of each wheel-side communication device 2a to 2d, or may be executed by the control unit 33 by transmitting the acceleration data or the data of the sensor angle α from each wheel-side communication device 2a to 2d to the vehicle-side communication device 3.

(b) Since the method (a) above requires an large amount of calculations, as shown in FIG. 8, only the sensor angle as at the measurement start timing Ts and the sensor angle de at the measurement end timing Te are calculated. During the period Tcal between the measurement start timing Ts and the measurement end timing Te, the number of rotation periods N of the wheels 5a to 5d is counted from the acceleration data. Since the sensor angle α changes in a sine waveform, the number of rotation periods N can be counted by measuring the number of times an arbitrary sensor angle α is reached when the arbitrary sensor angle α is defined as a reference angle.

For example, if the reference angle is 180°, then by detecting and counting the peaks of the acceleration Gx, the number of times the reference angle 180° has been passed, that is, the number of rotation periods N based on the wheel rotation, can be calculated. The peak of the acceleration Gx can be detected based on the acceleration Gx at the sampling point Sp shown in the upper part of FIG. 8. For example, the acceleration Gx at a sampling point Sp at any time t is defined as Gx(t), and Gx(t) is compared with the acceleration Gx(t−1), which is the acceleration Gx one cycle ago, and the sign of the difference of “Gx(t)−Gx(t−1)” is calculated. The peak of the acceleration Gx can be detected based on the feature that the signs become “+”, “+”, “−”, and “−”. Also, the number of rotation periods N may be calculated by counting the number of times that the condition is satisfied, for example, where the acceleration changes from less than a certain acceleration to equal to or greater than the certain acceleration.

The sensor angle α at each timing can be calculated using the acceleration Gz in addition to the acceleration Gx. This calculation method will be explained using the right wheels 5b and 5d as an example.

When the right wheels 5b, 5d are rotating as the vehicle 1 moves forward, the components of the acceleration Gx and acceleration Gz measured by the G sensor 22 with respect to the sensor angle α at which the wheel-side communication devices 2b, 2d are located are shown in FIG. 9. That is, the acceleration Gx forms a sensor angle α with respect to the component of gravitational acceleration, and the acceleration Gz is expressed as a component that forms a sensor angle α with respect to the Oo position on the rightmost side of the wheel center WO, i.e., the frontmost side of the vehicle 1. Here, the HPF (Gz) indicates that a high-pass filter process is executed on the detection signal of the acceleration Gz. By executing the high-pass filter process on the acceleration Gz, the centrifugal acceleration component accompanying the change in the traveling speed of the vehicle 1 is removed.

Therefore, the sensor angle α is expressed as in Expression 1, and can be calculated using the acceleration Gx and the acceleration Gz detected in the two axes by the G sensor 22.

α=tan⁻¹(HPF(Gz)/Gx) (Expression 1)

Here, when the sensor angle α is calculated using the two-axis acceleration Gx and acceleration Gz, the angle transitions differ between the left wheels 5a, 5c and the right wheels 5b, 5d, and therefore the rounding process at the measurement start timing Ts and the measurement end timing Te differs. Therefore, based on the changes in the two-axial acceleration Gx and acceleration Gz, the control unit 23 determines whether it is attached to the left wheel 5a, 5c or the right wheel 5b, 5d (hereinafter referred to as left/right determination), and then calculates the sensor angle α. The left/right determination can be made based on the amount of phase shift between the sine waveforms of the acceleration Gx and the acceleration Gz shown in the upper part of FIG. 4A and FIG. 4B. If the phase of the acceleration Gz leads the acceleration Gx by 90°, the control unit 23 can determine that it is attached to the left wheels 5a, 5c, and if it is delayed by 90°, the control unit 23 can determine that it is attached to the right wheels 5b, 5d.

First, in the case of the left wheels 5a and 5c, the accumulated angle θ is expressed as in Expression 2 using the number of rotation periods N, the sensor angle as at the measurement start timing, and the sensor angle de at the measurement end timing. Here, (A°) mod 360° indicates that, when A° is an angle exceeding 360°, an integer multiple of 360° is subtracted to make the angle less than 360°.

θ=(N−1)×360°+(αs+360°−αe)mod 360° (Expression 2)

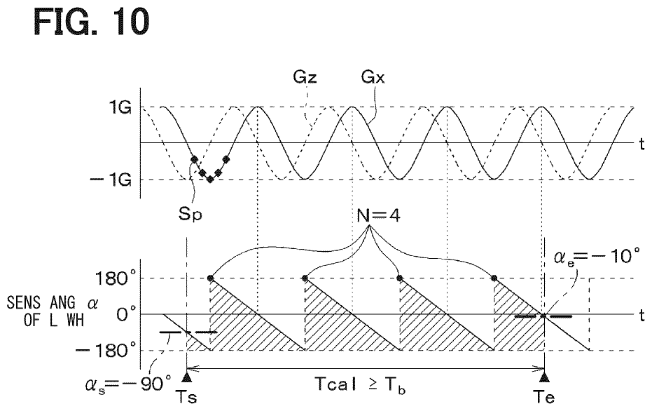

Therefore, when the acceleration Gx and the acceleration Gz change as shown in FIG. 10, if the sensor angle as is −90°, the sensor angle αe is −10°, and N=4, the accumulated angle θ will be calculated as 1360° as shown in Expression 3. The accumulated number of rotations can be calculated by dividing the accumulated angle θ by 360°. If the accumulated angle θ is 1360°, then an expression of “1360÷360=3.777 . . . ” is equal to the accumulated number of rotations.

θ=(4−1)×360°+{−90°+360°−(−10°)}=1360° (Expression 3)

On the other hand, in the case of the right wheels 5b and 5d, the accumulated angle θ is expressed as in Expression 4 using the number of rotation periods N, the sensor angle as at the measurement start timing, and the sensor angle αe at the measurement end timing.

θ=(N−1)×360°+(αe+360°−αs)mod 360° (Expression 4)

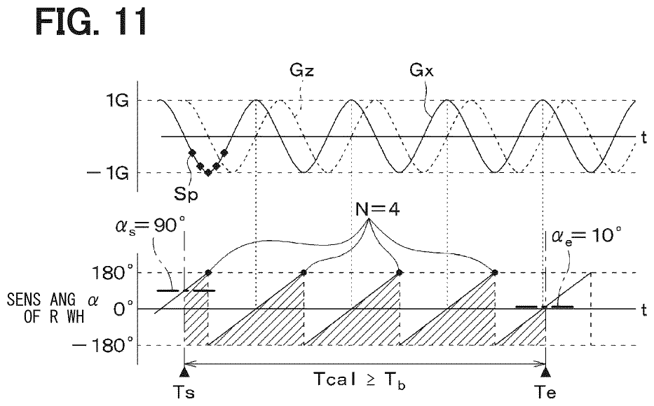

Therefore, when the acceleration Gx and the acceleration Gz change as shown in FIG. 11, if the sensor angle αs is 90°, the sensor angle αe is 10°, and N=4, the accumulated angle θ will be calculated as 1360° as shown in Expression 5.

θ=(4−1)×360°+{10°+360°−90°)}=1360° (Expression 5)

In this manner, the accumulated angle θ or the accumulated rotation number of each wheel-side communication device 2a to 2d can be calculated, and it is possible to specify to which of the wheels 5a to 5d each wheel-side communication device 2a to 2d is attached, thereby it is possible to detect the wheel position.

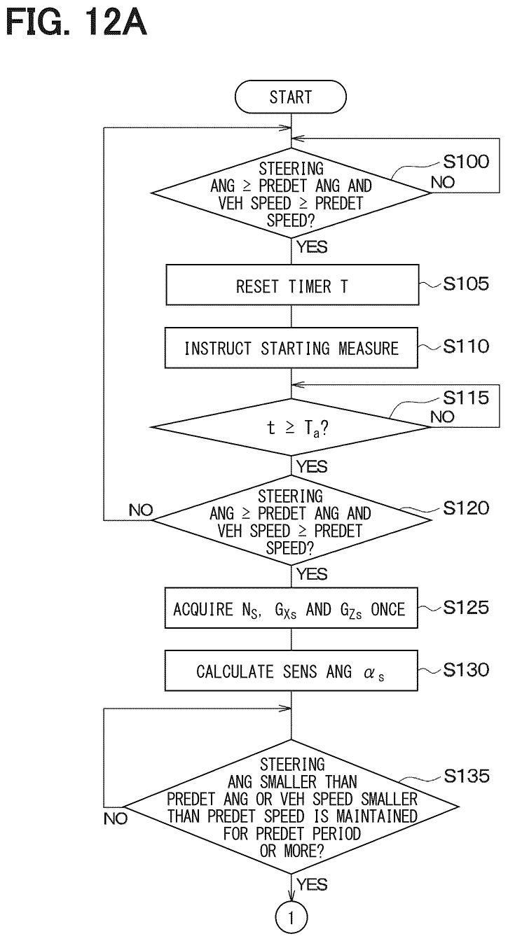

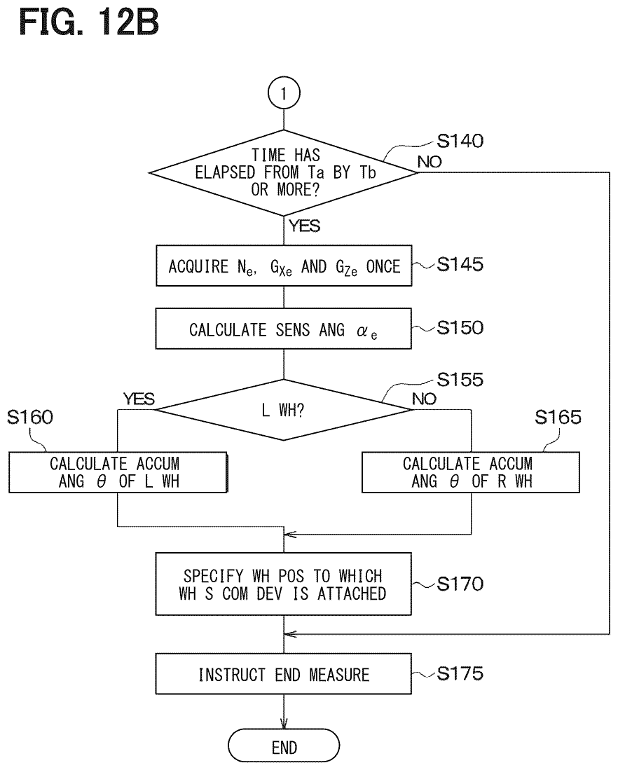

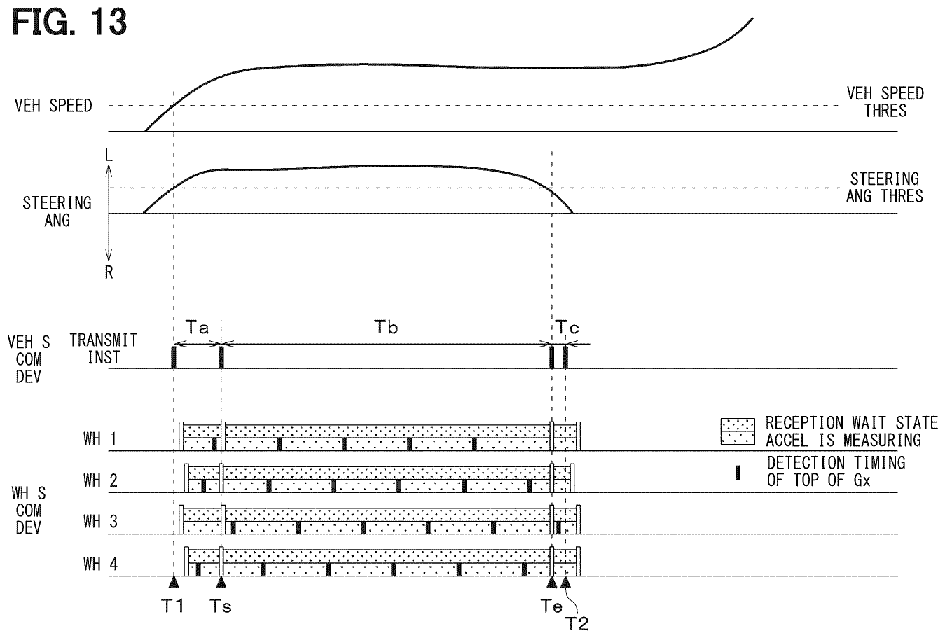

FIGS. 12A and 12B are flowcharts showing details of the wheel position detection process based on the above-described wheel position detection method. This wheel position detection process is executed by the control unit 33 at the predetermined period, for example, when the user presses a wheel position detection start switch (not shown) during tire replacement. The wheel position detection process will be described in detail with reference to the time charts shown in FIGS. 12A and 12B and FIG. 13 when the wheel position detection process is executed.

First, in step S100 in FIG. 12A, the control unit 33 determines whether the vehicle 1 is turning. This determination condition may be set arbitrarily, but here, if the condition of a steering angle of a certain angle or more and a vehicle speed of a certain speed or more is satisfied, it is determined that the vehicle 1 is turning. As shown in FIG. 13, a steering angle threshold value is set, and when the steering angle is equal to or greater than this steering angle threshold value, it is determined that the steering angle is equal to or greater than a certain angle. Similarly, as shown in FIG. 13, a speed threshold value is set, and when the speed is equal to or greater than this speed threshold value, it is determined that the speed is equal to or greater than a certain speed. This determination is made based on the detection signal from the steering angle sensor 7 and data relating to the vehicle speed transmitted from other ECUs. If the determination here is affirmative, the process proceeds to step S105, whereas if the determination here is negative, the process of step S100 is repeated.

In step S105, a timer t for measuring time in the control unit 23 is reset. Then, the process proceeds to step S110, where, as at time T1 in FIG. 13, the vehicle-side communication device 3 transmits an instruction signal to each of the wheel-side communication devices 2a to 2d to start the acceleration measurement. In response to this, the control unit 23 of each of the wheel-side communication units 2a to 2d switches from the periodic transmission mode to the wheel position detection mode. Then, the control unit 23 starts measuring the acceleration Gx and the acceleration Gz and counting the number of rotation periods N from the time when the control unit 23 receives the instruction, and transmits a response signal to the vehicle-side communication device 3 to acknowledge that the control unit 23 has received the instruction to start the measurement, and enters a reception waiting state. As a result, a connection is established between each of the wheel-side communication devices 2a to 2d and the vehicle-side communication device 3, and bidirectional communication is executed. In the case of BLE communication, the communication is possible based on the advertisement signal even if each wheel side communication device 2a to 2d is not in a reception waiting state, which is defined as a scan state, so that it is possible to transmit an instruction to start the measurement to each wheel side communication device 2a to 2d using this communication.

Thereafter, in step S115, it is determined whether or not the timer t has reached a predetermined time Ta. The predetermined time Ta here is a time that is set to be equal to or greater than the maximum delay time expected from when an instruction to start the measurement is issued until the wheel side communication devices 2a to 2d start measuring the acceleration and return a response signal, as shown in FIG. 13. If the timer t is equal to or greater than the predetermined time Ta, it is assumed that response signals have been returned from all of the wheel side communication units 2a to 2d, even if there is a delay in the return of the response signals. The process of this step is repeated until an affirmative determination is made in step S115, and if an affirmative determination is made in step S115, the process proceeds to step S120. In this embodiment, a response signal is returned from each of the wheel side communication devices 2a to 2d. Alternatively, it is also possible to simply determine that it has been elapsed a predetermined time Ta or more which is estimated that each of the wheel side communication devices 2a to 2d responds to an instruction and starts the acceleration measurement. Thus, the returning of the response signal may be optional.

In step S120, the same process as in step S100 is executed again to determine whether the condition suitable for the wheel position detection still continues. If the determination here is also affirmative, the process proceeds to step S125, and if the determination is negative, the process returns to step S100.

In step S125, as shown in FIG. 13, the control unit 33 notifies each of the wheel side communicators 2a to 2d that it is time to start measurement Ts. Specifically, the control unit 33 transmits an instruction signal to instruct to acquire the rotation period number N at the start, the start period number Ns in which the acceleration Gx and the acceleration Gz are obtained, the start acceleration Gxs, and the start acceleration Gzs, as an instruction for executing various processes to be executed at the measurement start timing Ts. In response to this instruction, the control unit 23 of each wheel side communication device 2a to 2d converts the start period number Ns, the start acceleration Gxs, and the start acceleration Gzs calculated, for example, by the method (b) described above, into a digital form as the data and returns the digital data to the vehicle side communication device 3, and then, the vehicle side communication device 3 receives the data.

Thereafter, the process proceeds to step S130, where the control unit 33 calculates the sensor angle αs at the measurement start timing Ts based on the start acceleration Gxs and start acceleration Gzs of the data received in step S125 and on the basis of the above-described expression 1. This process is executed for each received data, that is, for each of the wheel-side communication devices 2a to 2d, and the sensor angle αs is calculated for each of the wheel side communication devices 2a to 2d. Then, the process proceeds to step S135, where it is determined whether or not the vehicle 1 has finished turning. This determination condition may be set arbitrarily, but here it is determined that the vehicle 1 has finished turning when the condition that the steering angle or vehicle speed is maintained at or below a certain value for a certain period of time is satisfied. This determination is made based on the detection signal from the steering angle sensor 7 and data relating to the vehicle speed transmitted from other ECUs.

The certain steering angle and certain vehicle speed here may be the same values as those in steps S100 and S120, or may be values that are a predetermined amount smaller than those in steps S100 and S120, including a margin. If the condition in step S135 is satisfied, it is assumed that the turning will be ended. After that, the inner wheel difference becomes smaller and the data suitable for the wheel position detection cannot be acquired, so the data acquired up to this point is used for the wheel position detection. If the determination here is affirmative, the process proceeds to step S140 in FIG. 12B, whereas if the determination here is negative, the process of step S135 is repeated.

In step S140, it is determined whether or not a predetermined time Tb or more has elapsed since the timer t reached the predetermined time Ta, that is, whether or not the elapsed time from the measurement start timing Ts has reached the predetermined time Tb or more. The predetermined time Tb here is set as the minimum time from the measurement start timing Ts to the measurement end timing Te, as shown in FIG. 13, and is set arbitrarily based on the assumption that it is a time necessary to collect acceleration data to the extent that the wheel position can be detected with high accuracy. As shown in FIG. 8 and other drawings, the period Tcal from the measurement start timing Ts to the measurement end timing Te is set to a period equal to or greater than this predetermined time Tb. If the determination here is affirmative, the process proceeds to step S145, and if the determination here is negative, the process proceeds to step S175.

The processes of steps S135 and S140 may not be essential, and only one of them may be executed. For example, only step S140 may be executed, and once a predetermined time Tb or more has elapsed from the predetermined time Ta, it may be determined that sufficient data is available to execute the wheel position detection with high accuracy, and the process may proceed to step S145 and subsequent steps. Also, the wheel position detection may be executed using the data that is collected until the condition in step S135 is satisfied.

In step S145, as shown in FIG. 13, the control unit 33 notifies each of the wheel side communication devices 2a to 2d that it is the measurement end timing Te. Specifically, the control unit 33 transmits an instruction signal to instruct to acquire the rotation period number N at the end, the end period number Ns in which the acceleration Gx and the acceleration Gz are obtained, the end acceleration Gxe, and the end acceleration Gze, as an instruction for executing various processes to be executed at the measurement end timing Te. In response to this instruction, the control unit 23 of each wheel side communication device 2a to 2d converts the end period number Ne, the end acceleration Gxe, and the end acceleration Gze calculated, for example, by the method (b) described above, into a digital form as the data and returns the digital data to the vehicle side communication device 3, and then, the vehicle side communication device 3 receives the data.

Thereafter, the process proceeds to step S150, where the control unit 33 calculates the sensor angle αe at the measurement end timing Te based on the end acceleration Gxe and end acceleration Gze of the data received in step S145 and on the basis of the above-described expression 1. Then, the process proceeds to step S155, where it is determined whether the wheels are the left wheels 5a, 5c or not. The left/right determination may be made based on the gear position and the phases of the sine waveforms of the accelerations Gx and Gz. In other words, the control unit 23 detects whether the vehicle 1 is traveling forward or backward from the detection signal of the gear position sensor 8, and determines which of the accelerations Gx and Gz will be in a phase advanced state for the left wheels 5a, 5c and the right wheels 5b, 5d in response to the detection result. For example, as shown in FIG. 13, when the vehicle 1 is traveling forward, if the phase of the acceleration Gz leads the acceleration Gx by 90°, it can be determined that the wheel to which it is attached is the left wheel 5a, 5c. Also, if it is delayed by 90 degrees, it can be determined that it is attached to the right wheels 5b, 5d. When the left/right determination is to be executed by the vehicle-side communication device 3, data indicating the phase difference between the acceleration Gx and the acceleration Gz is also returned from each of the wheel-side communication devices 2a to 2d when the instruction in step S145 is issued. Alternatively, each wheel-side communication device 2a to 2d can execute the left/right determination based on the phase difference between the acceleration Gx and the acceleration Gz, and the data of the determination result is returned from each wheel-side communication device 2a to 2d when the instruction in step S145 is issued.

If the determination here is affirmative, the process proceeds to step S160, and if the determination here is negative, the process proceeds to step S165.

In step S160, since the wheels are the left wheels 5a and 5c, the accumulated angle θ for the left wheels 5a and 5c is calculated. The accumulated angle θ can be calculated using the above-described expression 2, and the number of rotation periods N in the expression 2 is calculated as the difference between the end number of periods Ne acquired in step S145 and the start number of periods Ns acquired in step S125.

Similarly, in step S165, since the wheels are the right wheels 5b and 5d, the accumulated angle θ for the right wheels 5b and 5d is calculated. The accumulated angle θ can be calculated using the above-described expression 4, and the number of rotation periods N in the expression 4 is calculated as the difference between the end number of periods Ne acquired in step S145 and the start number of periods Ns acquired in step S125.

The above-described processes in steps S150 to S165 are executed for each piece of received data, that is, for each of the wheel-side communication units 2a to 2d. Therefore, the accumulated angle θ is calculated for all the wheel side communication units 2a to 2d.

Next, the process proceeds to step S170, where the wheel position is detected based on the accumulated angle θ for the four wheels and the steering angle information, that is, the turning direction of the vehicle 1 indicated by the detection signal from the steering angle sensor 7. In other words, when the vehicle 1 turns clockwise, the magnitude of the accumulated angle θ has the following relationship of “left front wheel 5a>left rear wheel 5c>right front wheel 5b>right rear wheel 5d”. Conversely, when the vehicle 1 turns counterclockwise, the magnitude of the accumulated angle θ has the following relationship of “right front wheel 5b>right rear wheel 5d>left front wheel 5a>left rear wheel 5c”. Based on this relationship, it is possible to specify which of the four wheels 5a to 5d each of the four wheel-side communication devices 2a to 2d is attached to. For this reason, the ID information stored in the frame of each of the wheel-side communication devices 2a to 2d is registered in association with the wheel position, that is, with the wheel to which the wheel-side communication device 2a to 2d is attached. In this manner, various calculations and determination processes are executed during the period Tc from the measurement end timing Te in FIG. 13, and the specifying of the wheel position is completed. Then, the process proceeds to step S175, where the vehicle-side communication device 3 transmits an instruction to each of the wheel-side communication devices 2a to 2d to end the measurement, as shown at time T2 in FIG. 13, and the wheel position detection process is ended. Then, upon receiving this instruction, each of the wheel-side communication devices 2a to 2d ends the acceleration measurement and cancels the reception waiting state.

Although the accumulated angle θ is used to detect the wheel position here, the wheel position can also be detected in the same manner using the accumulated number of rotations, which is a value proportional to the accumulated angle θ.

Thereafter, the control unit 23 of each of the wheel-side communication devices 2a to 2d switches from the wheel position detection mode to the periodic transmission mode. Each of the wheel-side communication devices 2a to 2d then transmits a frame storing data relating to the tire air pressure together with the ID information to the vehicle-side communication device 3 at the predetermined regular transmission period. When this information is transmitted to the control unit 33 via the antenna 31, the control unit 33 executes various signal processing and calculations to determine the tire air pressure, and also specifies which of the wheels 5a to 5d the tire air pressure belongs to from the ID information stored in the frame. Then, the control unit 33 outputs an electric signal corresponding to the determined tire air pressure to the display 4. This allows the tire pressure to be displayed on the display 4 in a form that specifies which of the wheels 5a to 5d the tire air pressure belongs to, or a display indicating that the tire air pressure has dropped, thereby making it possible to inform the user of the tire condition.

As described above, in the TPMS of this embodiment, when the vehicle 1 is in a turning state, the sensor angle α of each wheel side communication device 2a to 2d is calculated based on the acceleration Gx and the acceleration Gz detected by the wheel side communication devices 2a to 2d. The accumulated angle θ and the accumulated number of revolutions are calculated from the sensor angle α, and the wheel position is detected based on the feature that the accumulated angle θ and the accumulated number of revolutions differ for each of the wheels 5a to 5d depending on the wheel position.

In this manner, it is possible to specify which of the four wheels 5a to 5d each of the four wheel-side communication devices 2a to 2d is attached to, and to execute the wheel position detection. Furthermore, according to this type of wheel position detection, it is possible to execute the wheel position detection more quickly and with higher accuracy, regardless of an error in the detection signal of the wheel speed sensor, since the wheel position detection can be executed without using the detection signal of the wheel speed sensor.

### Second Embodiment

The following describes the second embodiment of the present disclosure. In this embodiment, the wheel position detection is executed based on the acceleration of one axis, which is different from the first embodiment, and other points are the same as those in the first embodiment, so only the points that differ from the first embodiment will be described.

In the above first embodiment, a method of the wheel position detection in the case where two-axis acceleration is detected by the G sensor 22 was described. In the present embodiment, however, the wheel position detection based on one-axis acceleration detected by the G sensor 22 will be described.

Even if the G sensor 22 can detect acceleration along only one axis, or even if the G sensor 22 detects acceleration along two axes, the wheel position can be detected by using only one of the axes.

When the acceleration Gx is used, as shown in FIG. 9, the acceleration Gx is expressed as a component that forms a sensor angle α with respect to the component of the gravitational acceleration. Therefore, the absolute value of the sensor angle α can be calculated as shown in Expression 6. Here, “sgn” denotes a sign function, and “sgn (B)” is a function that is 1 when “B>0” is satisfied, 0 when “B=0” is satisfied, and −1 when “B<0” is satisfied. “dGx/dt” is the time derivative of the acceleration Gx, that is, the amount of change in the acceleration Gx per unit time, and may be the amount of change in the acceleration Gx between adjacent sampling points.

α=cos⁻¹(Gx)×sgn(dGx/dt) (Expression 6)

Furthermore, when the acceleration Gz is used, as shown in FIG. 9, the acceleration Gz is expressed as a component that forms a sensor angle α with respect to the position at the rightmost position with respect to the wheel center WO, that is, 0° position at the frontmost position of the vehicle 1 in the case of the right wheels 5b, 5d. Therefore, the absolute value of the sensor angle α can be calculated as shown in Expression 7.

α=sin⁻¹(HPF(Gx))×sgn(dHPF(Gx)/dt) (Expression 7)

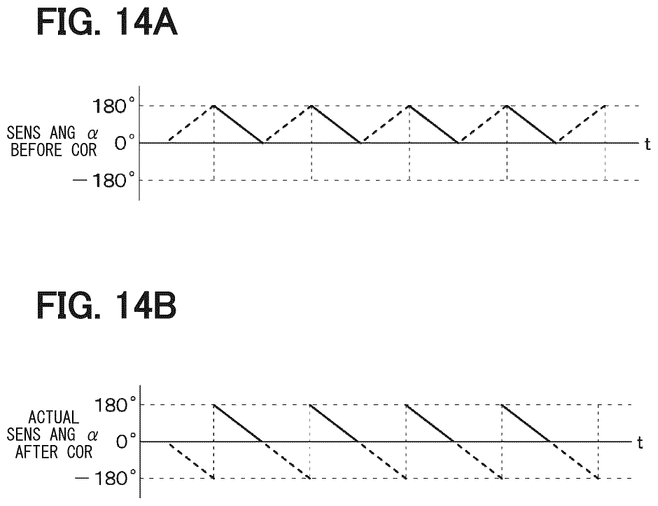

In Expression 6 and Expression 7, the absolute value of the sensor angle α is calculated. For this reason, as shown in FIG. 14A, the sensor angle α includes a dashed line portion that gradually increases with time, i.e., the portion where the change in sensor angle α per unit time is positive, i.e., “Δα>0”, and a solid line portion that gradually decreases with time, i.e., the portion where the change in sensor angle α per unit time is negative, i.e., “Δα<0”. If a minus sign is added to the dashed line portion where the absolute value of the sensor angle α gradually increases with time, the sensor angle α will have a waveform in which the angle gradually decreases with time, as shown in FIG. 14B. Therefore, if the absolute value of the sensor angle α is taken as the pre-correction angle, the actual sensor angle α can be obtained by calculating the post-correction angle by applying a negative sign to the part of the pre-correction angle where the absolute value of the sensor angle α gradually increases with time. That is, the actual sensor angle α is obtained based on the one-axis acceleration detected by the G sensor 22.

In addition, in the waveform of FIG. 14B, the positive and negative signs are reversed from those of the waveform of the sensor angle α in the case of the actual right wheels 5b and 5d, but this does not affect the accumulated angle θ or the integration of the accumulated number of rotations. On the other hand, since the waveforms of the sensor angle α of the right wheels 5b, 5d and the waveforms of the sensor angle α of the left wheels 5a, 5c can be aligned, it becomes possible to calculate the accumulated angle θ and the accumulated rotation number using the same calculation expression, for example, expression 2, thereby simplifying the calculation process. In addition, here, when the pre-correction angle gradually increases with time, a minus sign is added to the pre-correction angle to obtain the post-correction angle. Alternatively, when the pre-correction angle gradually decreases with time, a minus sign may also be added to the pre-correction angle to obtain the post-correction angle. In other words, only in one of the case where the pre-correction angle gradually increases with time and the case where the pre-correction angle gradually decreases with time, a negative sign is added to the pre-correction angle to acquire a post-correction angle, and the post-correction angle can be used as the actual sensor angle α.

Here, when acquiring the sensor angle α corresponding to the acceleration detected by the G sensor 22, it is necessary to determine whether or not to add a minus sign to the absolute value of the sensor angle α. This determination is made as follows. Although the following description will be given assuming that the wheel position is detected using the acceleration Gx, the same applies to the case where the acceleration Gz is used.

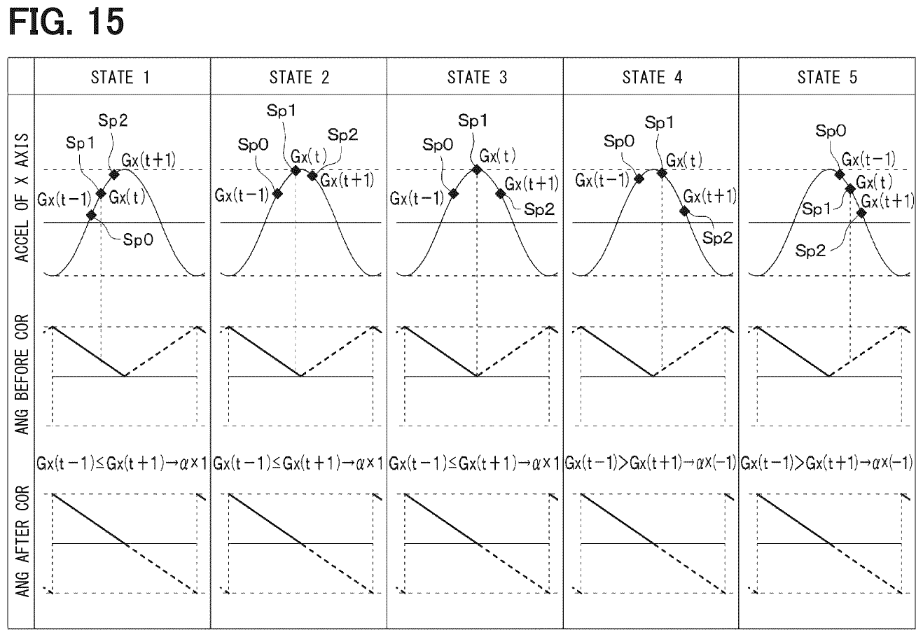

As shown in FIG. 15, the acceleration Gx on the X-axis has a sine waveform. Therefore, it is possible to determine whether or not to add a minus sign based on the relationship between the acceleration Gx(t) at the sampling point Sp1 and the accelerations Gx(t−1) and Gx(t+1) at sampling points Sp0 and Sp2 in the sampling periods before and after the sampling point Sp1.

State 1 indicates a relationship of “Gx(t−1)<Gx(t)<Gx(t+1)”, that is, a state in which the acceleration Gx gradually increases. In this state, at the sampling point Sp1, the pre-correction angle is in the middle of gradually decreasing with time. Therefore, there is no need to execute a correction by adding a minus sign to the pre-correction angle, and the pre-correction angle is treated as the post-correction angle as it is. Here, the correction coefficient is set to 1, and the sensor angle of “α×1” is set to the post correction angle.

State 2 indicates a relationship of “Gx(t−1)<Gx(t), Gx(t+1)”, that is, a state in which the acceleration Gx reaches a peak between the sampling points Sp1 and Sp2. In this state, at the sampling point Sp1, the pre-correction angle is also in the middle of gradually decreasing with time. Therefore, there is no need to execute a correction by adding a minus sign to the pre-correction angle, and the pre-correction angle is treated as the post-correction angle αs it is, similar to the state 1.

State 3 indicates a relationship of “Gx(t−1)<=Gx(t+1)<Gx(t)”, that is, a state in which the acceleration Gx reaches a peak around the sampling point Sp1. In this state, at the sampling point Sp1, it is not necessary to add a minus sign to the pre-correction angle yet although the situation is just before the pre-correction angle is switching from decreasing to increasing with time. Therefore, similarly to the state 1, the pre-correction angle is treated as the post-correction angle αs it is.

State 4 indicates a relationship of “Gx(t+1)<Gx(t−1)<=Gx(t+1)”, that is, the acceleration Gx reaches its peak between the sampling points Sp0 and Sp1. In this state, at the sampling point Sp1, it is necessary to add a minus sign to the pre-correction angle since the pre-correction angle has switched from decreasing to increasing with time. Therefore, the post-correction angle is calculated by adding a minus sign to the pre-correction angle. Here, the correction coefficient is set to 1, and the sensor angle of “α×1” is set to the post correction angle.

State 5 indicates a relationship of “Gx(t+1)<Gx(t)<Gx(t−1)”, that is, a state in which the acceleration Gx gradually decreases. In this state, at the sampling point Sp1, it is necessary to add a minus sign to the pre-correction angle since the pre-correction angle is in the middle of gradually increasing with time. Therefore, similarly to the state 4, the correction angle is calculated by adding a minus sign to the pre-correction angle.

Thus, whether or not to add a minus sign to the sensor angle α at the sampling point Sp1 is determined by the magnitude relationship between the sampling points Sp0 and Sp2 before and after the sampling point Sp1. In the states 1 and 2 in FIG. 15, since the relationship of “Gx(t−1)<Gx(t+1)” is satisfied, it is not necessary to add the minus sign, but in the states 4 and 5, since the relationship of “Gx(t−1)>Gx(t+1)” is satisfied, it is necessary to add the minus sign. In the state 3, the value of “Gx(t−1)” and the value of “Gx(t+1)” are the same or have almost no difference, but if the relationship of “Gx(t−1)<Gx(t+1)” is satisfied, it is not necessary to add the minus sign, and if the relationship of “Gx(t−1)>Gx(t+1)” is satisfied, it is necessary to add the minus sign.

In this manner, the actual sensor angle α can be calculated based on the one-axis acceleration detected by the G sensor 22. Then, once the actual sensor angle α is acquired, it becomes possible to detect the wheel position based on this actual sensor angle α, in the same manner as in the first embodiment.

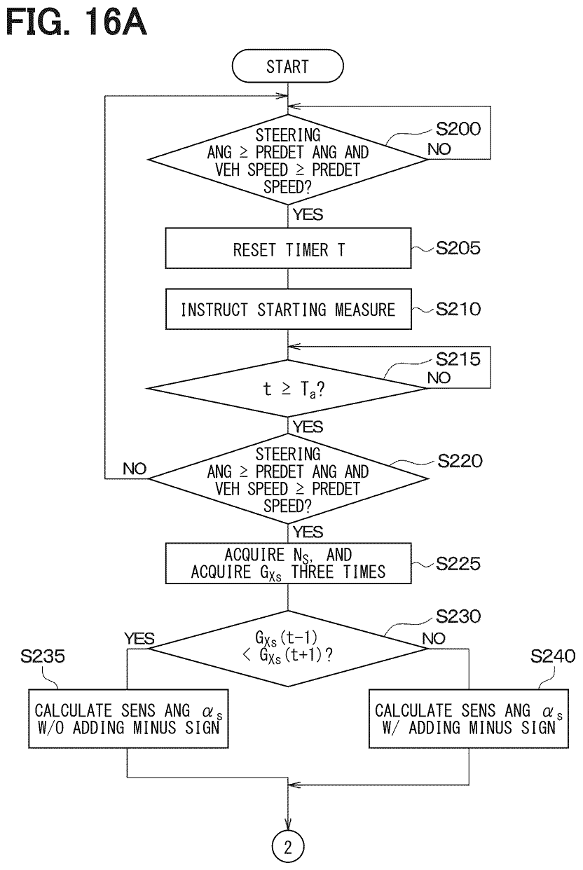

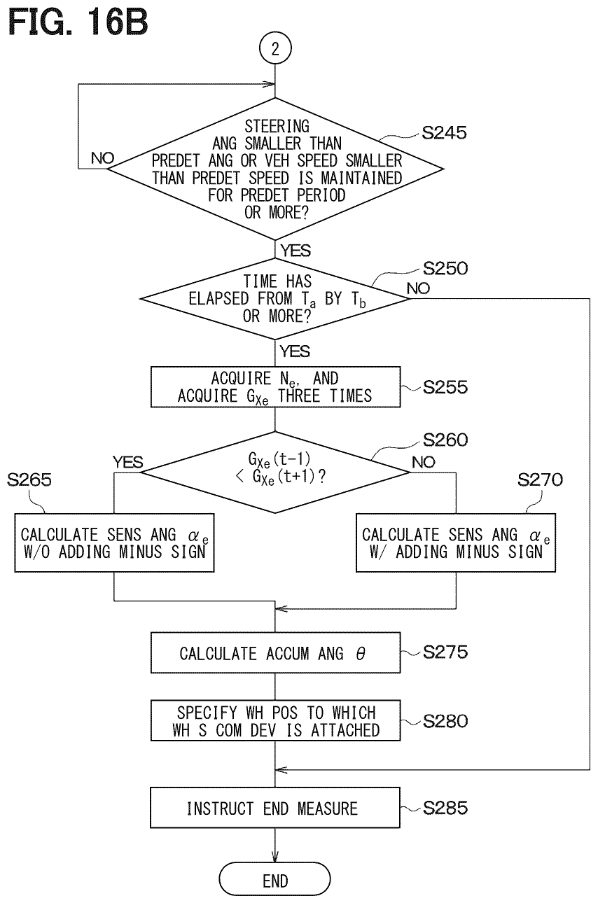

FIGS. 16A and 16B are flowcharts showing details of the wheel position detection process of this embodiment. This wheel position detection process is executed by the control unit 33 at the predetermined period, for example, when the user presses a wheel position detection start switch (not shown) during tire replacement.

First, in steps S200 to S220 in FIG. 16A, the same processes as in steps S100 to S120 in FIG. 12 in the first embodiment are executed. Then, the process proceeds to step S225, where the control unit 33 transmits to each of the wheel side communication devices 2a to 2d an instruction signal to instruct them to acquire the start period number Ns and the start acceleration Gxs for three sampling periods. For the start acceleration Gxs for three sampling periods, the signal transmission timing is set to the measurement start timing Ts, and the start acceleration Gxs(t) at the measurement start timing Ts and the start accelerations Gxs(t−1) to Gxs(t+1) for three periods are set. In response to this instruction, the control unit 23 of each wheel side communication device 2a to 2d converts the start period number Ns, and the start acceleration Gzs calculated, for example, by the method (b) described above, into a digital form as the data and returns the digital data to the vehicle side communication device 3, and then, the vehicle side communication device 3 receives the data.

Next, the process proceeds to step S230, where the start accelerations Gxs(t−1) and Gxs(t+1) in the sampling periods before and after the measurement start timing Ts are compared to determine whether the relationship of “Gxs(t−1)<Gxs(t+1)” is satisfied.

If the determination here is affirmative, the flow proceeds to step S235, in which the sensor angle αs at the measurement start timing Ts is calculated based on Expression 8 since there is no need to add a minus sign to the pre-correction angle.

αs=cos⁻¹(Gxs)×sgn(dGxs/dt) (Expression 8)

If the result is negative, the process proceeds to step S240, where the sensor angle αs at the measurement start timing Ts is calculated based on Expression 9 since it is necessary to add a minus sign to the pre-correction angle.

αs=−cos⁻¹(Gxs)×sgn(dGxs/dt) (Expression 9)

The above-described processes in steps S230 to S240 are executed for each piece of received data, that is, for each of the wheel-side communication units 2a to 2d.

Thereafter, in steps S245 and S250, the same processes as in steps S135 and S140 in FIG. 12 in the first embodiment are executed. If an affirmative determination is made in step S250, the process proceeds to step S255, whereas if a negative determination is made, the process proceeds to step S285.

In step S255, the control unit 33 transmits to each of the wheel side communicators 2a to 2d an instruction signal to instruct them to acquire the end period number Ne and the end acceleration Gxe for three sampling periods. The end acceleration Gxe for three sampling periods indicates the end acceleration Gxe(t) at the measurement end timing Te and the end acceleration Gxe(t−1) to Gxe(t+1) for three periods before and after the measurement end timing Te when the signal transmission timing is defined as the measurement end timing Te. In response to this instruction, the control unit 23 of each wheel side communication device 2a to 2d converts the end period number Ne, and the end acceleration Gze calculated, for example, by the method (b) described above, into a digital form as the data and returns the digital data to the vehicle side communication device 3, and then, the vehicle side communication device 3 receives the data.

Next, the process proceeds to step S260, where the end accelerations Gxe(t−1) and Gxe(t+1) in the sampling periods before and after the measurement start timing Te are compared to determine whether the relationship of “Gxe(t−1)<Gxe(t+1)” is satisfied.

If the determination here is affirmative, the flow proceeds to step S265, in which the sensor angle de at the measurement end timing Te is calculated based on Expression 10 since there is no need to add a minus sign to the pre-correction angle.

αe=cos⁻¹(Gxe)×sgn(dGxe/dt) (Expression 10)

If the result is negative, the process proceeds to step S270, where the sensor angle de at the measurement end timing Te is calculated based on Expression 11 since it is necessary to add a minus sign to the pre-correction angle.

αe=−cos⁻¹(Gxe)×sgn(dGxe/dt) (Expression 11)

The above-described processes in steps S255 to S270 are executed for each piece of received data, that is, for each of the wheel-side communication units 2a to 2d.

Thereafter, the process proceeds to step S275, where the accumulated angle θ is calculated. At this time, as shown in FIG. 14B, since the sensor angle α is a post correction angle that gradually decreases with time regardless of whether it is the left wheels 5a, 5c or the right wheels 5b, 5d, the accumulated angle θ can be calculated from Expression 2 for both the left wheels 5a, 5c and the right wheels 5b, 5d.

Then, the process proceeds to step S280, where the wheel position detection is executed based on the accumulated angle θ of the four wheels and the steering angle information, i.e., the turning direction of the vehicle 1 indicated by the detection signal of the steering angle sensor 7, as in step S170 of FIG. 12 according to the first embodiment. Then, when it is determined which of the four wheels 5a to 5d each of the four wheel-side communication devices 2a to 2d is attached to, the ID information stored in the frame of each wheel-side communication device 2a to 2d is connected to the wheel position and registered. Finally, the process proceeds to step S285, where the vehicle-side communication device 3 transmits an instruction to each of the wheel-side communication devices 2a to 2d to end the measurement, and the wheel position detection process is ended.

Although the accumulated angle θ is used to detect the wheel position here, the wheel position can also be detected in the same manner using the accumulated number of rotations, which is a value proportional to the accumulated angle θ.

Thereafter, similarly to the first embodiment, the tire air pressure detection is executed while specifying which of the wheels 5a to 5d each of the wheel-side communication devices 2a to 2d is attached to based on the result of the wheel position detection.

In this manner, when the vehicle 1 is turning, the accumulated angle θ and the accumulated number of rotations can be calculated based on the acceleration of one axis detected by the G sensor 22, and the wheel position can be detected. Accordingly, effects similar to the effects of the first embodiment can be achieved.

Furthermore, when the wheel position detection is executed based on one-axis acceleration as in this embodiment, there is no need to execute the left/right determination, and when acceleration Gx is used, there is no need to execute the high-pass filter processing as in the case of using the acceleration Gz, so that it is possible to simplify the system. Here, when the wheel position detection is executed using two-axis acceleration Gx and acceleration Gz as in the first embodiment, a larger amount of acceleration data is used, so the sensor angle α can be calculated more accurately, so that it is possible to execute more accurate wheel position detection.

### Other Embodiments

Although the present disclosure has been described on the basis of the embodiments described above, the present disclosure is not limited to the embodiments but also includes various modifications and modifications within an equivalent range. In addition, while the various combinations and configurations, which are preferred, other combinations and configurations, including more, less or only a single element, are also within the spirit and scope of the present disclosure.

(i) For example, in each of the above embodiments, the wheel position is detected using the accumulated angle θ. Alternatively, the wheel position may be detected using the accumulated number of rotations.

(ii) In each of the above embodiments, an example of inputting an instruction to start the wheel position detection is described as a case when a user presses a wheel position detection start switch (not shown), such as when changing tires. Alternatively, the start instruction may be input in other ways. For example, the wheel position detection may be executed when an automobile repair shop uses a tool to input an instruction to start the wheel position detection. Furthermore, the wheel position detection may be executed when a start switch such as an ignition switch is pressed while the vehicle 1 has not been started for a predetermined period of time or longer.

(iii) In each of the above embodiments, an example is described of a case in which the clock synchronization between each wheel-side communication device 2a to 2d and the vehicle-side communication device 3 is not executed immediately before sampling of the acceleration measurement. Alternatively, the clock synchronization may also be executed.

(iv) In the above embodiments, each wheel-side communication device 2a to 2d acquires the rotation period number N and the acceleration Gx, transmits the data to the vehicle-side communication device 3, and the vehicle-side communication device 3 calculates the sensor angle α. Alternatively, each of the wheel-side communication devices 2 a to 2 d may execute the calculation of the sensor angle α and transmit the data on the rotation period number N and the sensor angle α to the vehicle-side communication device 3.

(v) In each of the above embodiments, when calculating the sensor angle αs at the measurement start timing Ts and the sensor angle de at the measurement end timing Te, the acceleration Gx at the sampling points Sp before and after those timings, i.e., Gx(t−1), Gx(t), and G (t+1), is used. This is merely one example, and it is also possible to use Gx(t−2), Gx(t−1), and G (t), which are the accelerations Gx at three sampling points Sp including the measurement start timing Te or the measurement end timing Te and one sampling point just before the measurement start timing Te or the measurement end timing Te and another sampling point just before the one sampling point. Alternatively, it is also possible to use Gx(t), Gx(t+1), and G (t+2), which are the accelerations Gx at three sampling points Sp including the measurement start timing Te or the measurement end timing Te and one sampling point just after the measurement start timing Te or the measurement end timing Te and another sampling point just after the one sampling point. Further, the number of sampling points Sp1 is not limited to three, and the sensor angle α may be calculated using the acceleration Gx at two or four or more sampling points Sp1.

(vi) In the above embodiment, the wheel position detection device provided in the vehicle 1 equipped with four traveling wheels 5a to 5d has been described. Alternatively, the present embodiments can also be applied to a vehicle having a plurality of traveling wheels which are more than four wheels. In this case as well, the accumulated angle θ and the accumulated rotation number are largest for the front wheel on the outer side of the turn, and are smallest for the rear wheel on the inner side of the turn. In this way, since the order of magnitude of the accumulated angle θ and the accumulated number of rotations is determined according to the wheel position, the wheel position can be detected based on this order.

(vii) In each of the above embodiments, one of the conditions for starting the acceleration measurement is when a steering angle of a certain angle or more has occurred. Alternatively, if the steering angle is expressed as a positive value for a left turn and a negative value for a right turn, the start condition may simply be when the absolute value of the steering angle is greater than or equal to a certain angle.

(viii) The controller and the method thereof described in the present disclosure may be realized by a dedicated computer provided by configuring a processor and a memory programmed to execute one or more functions embodied by a computer program. Alternatively, the controller and the method described in the present disclosure may be implemented by a special purpose computer configured as a processor with one or more special purpose hardware logic circuits. Alternatively, the control unit and the method thereof described in the present disclosure may be implemented by a combination of (i) a special purpose computer including a processor programmed to execute one or more functions by executing a computer program and a memory and (ii) a special purpose computer including a processor with one or more dedicated hardware logic circuits. The computer program may also be stored on a computer-readable and non-transitory tangible storage medium as an instruction executed by a computer.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A wheel position detection device for a vehicle, the wheel position detection device comprising:
a wheel-side communication device attached to each of a plurality of wheels having tires; and
a vehicle-side communication device provided on a vehicle body side, wherein:
the wheel-side communication device respectively attached to each of the plurality of wheels includes:
an acceleration sensor that detects a circumferential acceleration that is an acceleration along a circumference direction of each wheel to which the wheel side communication device is attached and a radial acceleration that is an acceleration along a radial direction of each wheel to which the wheel-side communication device is attached;
a first control unit that stores a detection result of the acceleration sensor and generates a frame that stores individual identification information assigned to each wheel-side communication unit; and
a first communication unit that executes bidirectional communication with the vehicle-side communication device;
the bidirectional communication includes a transmission of the frame;
the vehicle-side communication device includes:
a second communication unit that receives the frame and transmits an instruction signal to each wheel-side communication device; and
a second control unit that determines which of the plurality of wheels the wheel-side communication device that has transmitted the frame is attached to, and associates and registers a relationship between the identification information and the plurality of wheels;
the second control unit transmits a measurement start timing and a measurement end timing to each wheel-side communication device so as to cause the wheel-side communication device to execute an acceleration measurement when the vehicle is in a turning state;
an angle at which each wheel-side communication device is located with respect to a wheel center of the wheel to which the wheel-side communication device is attached is defined as a sensor angle;
the second control unit or the first control unit provided in each wheel-side communication device calculates the sensor angle based on the circumferential acceleration and the radial acceleration;
the second control unit or the first control unit provided in each wheel-side communication device calculates an accumulated angle acquired by accumulating a change in the sensor angle from the measurement start timing to the measurement end timing, or an accumulated number of rotations of the wheel-side communication device rotated around the wheel center, based on the sensor angle; and
the second control unit specifies which of the plurality of wheels each wheel side communication device is attached to, based on the accumulated angle in each wheel-side communication device or a magnitude of the accumulated number of rotations.

2. The wheel position detection device according to claim 1, wherein:
the second control unit or the first control unit provided in each wheel-side communication device executes a right and left determination for specifying whether the wheel to which the wheel-side communication device is attached is a left wheel or a right wheel, based on a turning direction of the vehicle, a phase of the circumferential acceleration and a phase of the radial acceleration;
the second control unit or the first control unit provided in each wheel-side communication device calculates the sensor angle based on a result of the right and left determination, the circumferential acceleration, and the radial acceleration, and calculates a numerical number of rotation periods of the wheel to which the wheel side communication device is attached during a period from the measurement start timing to the measurement end timing; and
the second control unit or the first control unit provided in each wheel-side communication device calculates the accumulated angle or the accumulated number of rotations based on the sensor angle and the numerical number of rotation periods.

3. The wheel position detection device according to claim 1, wherein:
the second control unit transmits an instruction signal to start the acceleration measurement when it is determined that the vehicle is turning;
the second control unit notifies that it is the measurement start timing when a predetermined time has elapsed;
each wheel-side communication devices is estimated to start the acceleration measurement in response to the instruction signal after the predetermined time has elapsed; and
the second control unit notifies that it is the measurement end timing when it is determined that the vehicle has finished turning.

4. The wheel position detection device according to claim 1, further comprising:
at least one of (i) a circuit and (ii) a processor with a memory storing computer program code executable by the processor; and
at least one of (i) another circuit and (ii) another processor with another memory storing computer program code executable by the processor, wherein:
the at least one of the circuit and the processor configured to cause the wheel position detection device to implement at least one of: the first control unit; and
the at least one of the another circuit and the another processor configured to cause the wheel position detection device to implement at least one of: the second control unit.

5. The wheel position detection device according to claim 1, wherein:
the wheel position detection device is applied to a tire pressure monitoring system;
the second control unit specifies which of the plurality of wheels each wheel side communication device is attached to without a detection signal of a wheel speed sensor;
the wheel-side communication device respectively attached to each of the plurality of wheels further includes a sensing unit that detects a tire pressure of each of the plurality of wheels having tires at a predetermined sampling period;
the frame further includes data of a detection result of the tire pressure of each of the plurality of wheels having tires;
the second control unit acquires the tire pressure of each of the plurality of wheels having tires based on the data in the frame;
the second control unit compares the tire pressure of each of the plurality of wheels with a predetermined threshold; and
the second control unit notifies a driver of the vehicle that the tire pressure of each of the plurality of wheels has dropped when the second control unit determined that the tire pressure of each of the plurality of wheels is smaller than the predetermined threshold.

6. The wheel position detection device according to claim 3, wherein:
the second control unit determines that the vehicle is turning when the vehicle is travelling under a condition that a steering angle is equal to or greater than a certain angle and a vehicle speed is equal to or greater than a certain speed.

7. A wheel position detection device for a vehicle, the wheel position detection device comprising:
a wheel-side communication device attached to each of a plurality of wheels having tires; and
a vehicle-side communication device provided on a vehicle body side, wherein:
the wheel-side communication device respectively attached to each of the plurality of wheels includes:
an acceleration sensor that detects one of a circumferential acceleration that is an acceleration along a circumference direction of each wheel to which the wheel side communication device is attached and a radial acceleration that is an acceleration along a radial direction of each wheel to which the wheel-side communication device is attached;
a first control unit that stores a detection result of the acceleration sensor and generates a frame that stores individual identification information assigned to each wheel-side communication unit; and
a first communication unit that executes bidirectional communication with the vehicle-side communication device;
the bidirectional communication includes a transmission of the frame;
the vehicle-side communication device includes:
a second communication unit that receives the frame and transmits an instruction signal to each wheel-side communication device; and
a second control unit that determines which of the plurality of wheels the wheel-side communication device that has transmitted the frame is attached to, and associates and registers a relationship between the identification information and the plurality of wheels;
the second control unit transmits a measurement start timing and a measurement end timing to each wheel-side communication device so as to cause the wheel-side communication device to execute an acceleration measurement when the vehicle is in a turning state;
an angle at which each wheel-side communication device is located with respect to a wheel center of the wheel to which the wheel-side communication device is attached is defined as a sensor angle;
the second control unit or the first control unit provided in each wheel-side communication device calculates the sensor angle based on only one of the circumferential acceleration and the radial acceleration;
the second control unit or the first control unit provided in each wheel-side communication device calculates an accumulated angle acquired by accumulating a change in the sensor angle from the measurement start timing to the measurement end timing, or an accumulated number of rotations of the wheel-side communication device rotated around the wheel center, based on the sensor angle; and
the second control unit specifies which of the plurality of wheels each wheel side communication device is attached to, based on the accumulated angle in each wheel-side communication device or a magnitude of the accumulated number of rotations.

8. The wheel position detection device according to claim 7, wherein:
the second control unit or the first control unit provided in each wheel-side communication device acquires a pre-correction angle indicated by an absolute value of the sensor angle based on the one of the circumferential acceleration and the radial acceleration;
the second control unit or the first control unit provided in each wheel-side communication device acquires a post-correction angle by adding a minus sign to the pre-correction angle only in one of a case where the pre-correction angle gradually increases with time or a case where the pre-correction angle gradually decreases with time;
the second control unit or the first control unit provided in each wheel-side communication device uses the post correction angle αs an actual sensor angle, and calculates a numerical number of rotation periods of the wheel to which the wheel side communication device is attached during a period from the measurement start timing to the measurement end timing; and
the second control unit or the first control unit provided in each wheel-side communication device calculates the accumulated angle or the accumulated number of rotations based on the sensor angle and the numerical number of rotation periods.

9. The wheel position detection device according to claim 7, wherein:
the second control unit transmits an instruction signal to start the acceleration measurement when it is determined that the vehicle is turning;
the second control unit notifies that it is the measurement start timing when a predetermined time has elapsed;
each wheel-side communication devices is estimated to start the acceleration measurement in response to the instruction signal after the predetermined time has elapsed; and
the second control unit notifies that it is the measurement end timing when it is determined that the vehicle has finished turning.

10. The wheel position detection device according to claim 7, further comprising:
at least one of (i) a circuit and (ii) a processor with a memory storing computer program code executable by the processor; and
at least one of (i) another circuit and (ii) another processor with another memory storing computer program code executable by the processor, wherein:
the at least one of the circuit and the processor configured to cause the wheel position detection device to implement at least one of: the first control unit; and
the at least one of the another circuit and the another processor configured to cause the wheel position detection device to implement at least one of: the second control unit.

11. The wheel position detection device according to claim 7, wherein:
the wheel position detection device is applied to a tire pressure monitoring system;
the second control unit specifies which of the plurality of wheels each wheel side communication device is attached to without a detection signal of a wheel speed sensor;
the wheel-side communication device respectively attached to each of the plurality of wheels further includes a sensing unit that detects a tire pressure of each of the plurality of wheels having tires at a predetermined sampling period;
the frame further includes data of a detection result of the tire pressure of each of the plurality of wheels having tires;
the second control unit acquires the tire pressure of each of the plurality of wheels having tires based on the data in the frame;
the second control unit compares the tire pressure of each of the plurality of wheels with a predetermined threshold; and
the second control unit notifies a driver of the vehicle that the tire pressure of each of the plurality of wheels has dropped when the second control unit determined that the tire pressure of each of the plurality of wheels is smaller than the predetermined threshold.

12. The wheel position detection device according to claim 9, wherein:
the second control unit determines that the vehicle is turning when the vehicle is travelling under a condition that a steering angle is equal to or greater than a certain angle and a vehicle speed is equal to or greater than a certain speed.
